(19) United States
(12) Patent Application Publication
(10) Pub. No.: US 2007/0250507 A1
(43) Pub. Date: Oct. 25, 2007

(54) ELECTRONIC FILE SHARING

(75) Inventors: John C. Haager, Bonney Lake, WA (US); Mike R. Manzano, Seattle, WA (US)

Correspondence Address: BLACK LOWE & GRAHAM, PLLC, 701 FIFTH AVENUE, SUITE 4800, SEATTLE, WA, 98104, US

(73) Assignee: Topia Technology, Tacoma, WA (US)

(21) Appl. No.: 11/739,083

(22) Filed: Apr. 23, 2007

Related U.S. Application Data
(60) Provisional application No. 60/745,354, filed on Apr. 21, 2006.
(60) Provisional application No. 60/803,831, filed on Jun. 2, 2006.
(60) Provisional application No. 60/823,494, filed on Aug. 24, 2006.
(60) Provisional application No. 60/825,852, filed on Sep. 15, 2006.
(60) Provisional application No. 60/869,451, filed on Dec. 11, 2006.
(60) Provisional application No. 60/910,747, filed on Apr. 9, 2007.

(51) Int. Cl. G06F 17/30

(52) U.S. Cl. 707/8

(57) ABSTRACT

A system includes a server and a source client executable on a first electronic device in communication with the server. The source client is operable to send a file to the server. The system further includes a recipient client executable on a second electronic device in communication with the server. The recipient client is operable to retrieve from the server a first portion of a plurality of portions of the file before the server has received the entirety of the file from the source client.

### PRIORITY CLAIM

The present application claims priority from U.S. Provisional Application No. 60/745,354 filed Apr. 21, 2006; U.S. Provisional Application No. 60/803,831 filed Jun. 2, 2006; U.S. Provisional Application No. 60/823,494 filed Aug. 24, 2006; U.S. Provisional Application No. 60/825,852 filed Sep. 15, 2006; U.S. Provisional Application No. 60/869,451 filed Dec. 11, 2006; and U.S. Provisional Application No. 60/910,747 filed on Apr. 9, 2007 which are herein incorporated by reference

### FIELD OF THE INVENTION

This invention relates generally to computer-implemented processes and, more specifically, to sharing of electronic files among electronic devices.

### BACKGROUND OF THE INVENTION

Computer-network users typically exchange large files using awkward prior-art methods such as e-mail attachments or file transfer protocol (FTP) sites. Most email systems limit the size of attachments, and, as a result, users are forced to send multiple e-mails with discrete files attached to each. FTP sites are typically only moderately secure and their use is often difficult to manage for inexperienced users.

Other problems with the prior art not described above can also be overcome using the teachings of embodiments of the present invention, as would be readily apparent to one of ordinary skill in the art after reading this disclosure.

### SUMMARY OF THE INVENTION

In an embodiment of the invention, a system includes a server and a source client executable on a first electronic device in communication with the server. The source client is operable to send a file to the server. The system further includes a recipient client executable on a second electronic device in communication with the server. The recipient client is operable to retrieve from the server a first portion of a plurality of portions of the file before the server has received the entirety of the file from the source client.

### BRIEF DESCRIPTION OF THE DRAWINGS

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a functional block diagram illustrating file sharing according to an embodiment of the invention;

FIG. 4 is a flow diagram illustrating a first method according to an embodiment of the invention; and

FIG. 5 is a flow diagram illustrating a second method according to an embodiment of the invention.

### DETAILED DESCRIPTION OF THE PREFERRED EMBODIMENT

An embodiment of the invention leverages remote programming concepts by utilizing processes called mobile agents (sometimes referred to as mobile objects or agent objects). Generally speaking, these concepts provide the ability for an object (the mobile agent object) existing on a first (“host”) computer system to transplant itself to a second (“remote host”) computer system while preserving its current execution state. The operation of a mobile agent object is described briefly below.

The instructions of the mobile agent object, its preserved execution state, and other objects owned by the mobile agent object are packaged, or “encoded,” to generate a string of data that is configured so that the string of data can be transported by all standard means of communication over a computer network. Once transported to the remote host, the string of data is decoded to generate a computer process, still called the mobile agent object, within the remote host system. The decoded mobile agent object includes those objects encoded as described above and remains in its preserved execution state. The remote host computer system resumes execution of the mobile agent object which is now operating in the remote host environment.

While now operating in the new environment, the instructions of the mobile agent object are executed by the remote host to perform operations of any complexity, including defining, creating, and manipulating data objects and interacting with other remote host computer objects.

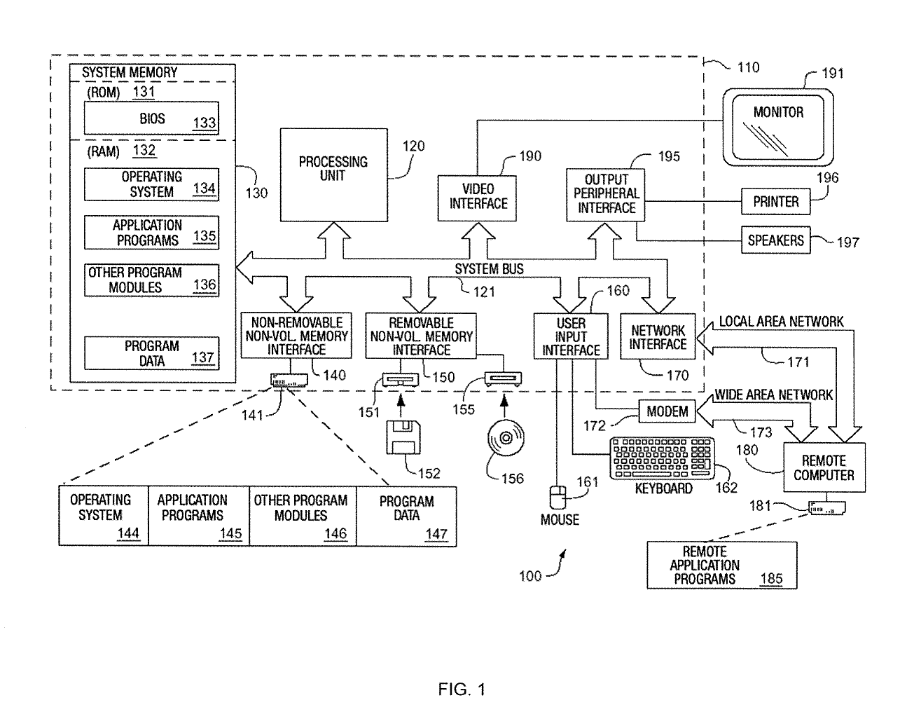

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

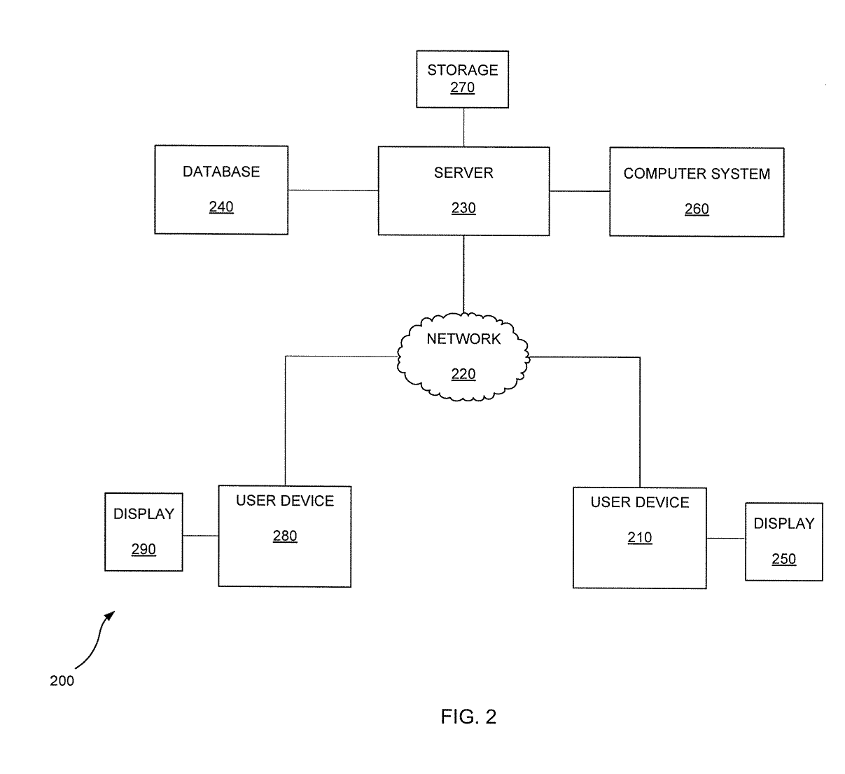

Referring now to FIG. 2, an embodiment of the present invention can be described in the context of an exemplary computer network system 200 as illustrated. System 200 includes electronic user devices 210, 280, such as personal computers or workstations, that are linked via a communication medium, such as a network 220 (e.g., the Internet), to an electronic device or system, such as a server 230. The server 230 may further be coupled, or otherwise have access, to a database 240, electronic storage 270 and a computer system 260. Although the embodiment illustrated in FIG. 2 includes one server 230 coupled to two user devices 210, 280 via the network 220, it should be recognized that embodiments of the invention may be implemented using two or more such user devices coupled to one or more such servers.

In an embodiment, each of the user devices 210, 280 and server 230 may include all or fewer than all of the features associated with the computer 110 illustrated in and discussed with reference to FIG. 1. User devices 210, 280 include or are otherwise coupled to a computer screen or display 250, 290, respectively. User devices 210, 280 can be used for various purposes including both network- and local-computing processes.

The user devices 210, 280 are linked via the network 220 to server 230 so that computer programs, such as, for example, a browser or other applications, running on the user devices 210, 280 can cooperate in two-way communication with server 230. Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

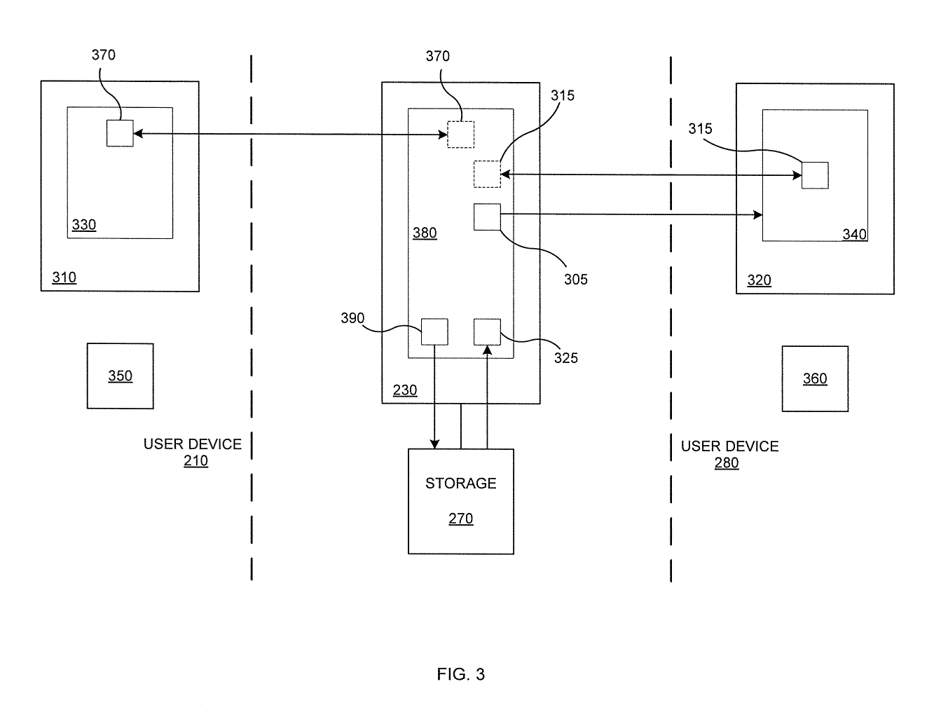

Referring now to FIG. 3, illustrated is functionality of an embodiment of the invention allowing a user (not shown) of the user device 210 to transfer a file to the user device 280. In an embodiment, an administrator (not shown) of the server 230 or other appropriate electronic device transfers a file-transfer application to the user devices 210, 280 for installation thereon. Once installed on the user devices 210, 280, the file-transfer application provides file-transfer clients 310, 320 executable by the user devices 210, 280, respectively. Each of the file-transfer clients 310, 320 includes a respective mobile-agent runtime environment 330, 340. The mobile-agent runtime environment 330, 340 include portions of memory of the user devices 210, 280 dedicated to allowing a mobile object the ability to perform operations that the mobile object is programmed to carry out. Also included in the file-transfer application are user interfaces 350, 360 that are displayable on the displays 250, 290, respectively. In an embodiment, the interfaces 350, 360 correspond to respective electronic folders into which files may be placed. Each such electronic folder may be assigned a user group defining users having permission to receive and/or send files via a particular folder.

To initiate sharing of a file with a user of the user device 280, the user of the user device 210 may place a file into the folder corresponding to the interface 350 and with which the user device 280 has been associated as a recipient. The user may do so through conventional actions such as, for example, “dragging and dropping” an icon representing the file into the interface 350 or opening the file using commands associated with the interface 350. The source client 310 monitors the folder corresponding to the interface 350. Upon noting the placement of the file in the interface 350, the source client 310 polls the server 230 to determine the recipient group including, in this case, the user device 280 and places a request with the server to share the file.

In response to the file-sharing request, the server 230 returns a transfer token (not shown) the source client 310. In an embodiment, the transfer token includes a data string that functions as a transaction identifier corresponding to the file. Upon receiving the transfer token, the source client 310 creates a transfer mobile object (TMO) 370 that includes the token and information characterizing the file (e.g., recipient identification, sender identification, file name, file workspace (i.e., name of folder corresponding to the interface 350 and into which the file was placed for sharing), file size, etc.) (collectively, “file-transfer information”).

The TMO 370 migrates to a mobile-agent runtime environment 380 executing on the server 230 and creates a proxy object 390 that functions as the TMO's server-side agent for the file transfer. In an embodiment, the proxy 390 is, itself, a mobile object. After creating the proxy 390, the TMO 370 returns to the source client 310.

Once the TMO 370 returns to the user device 210, it establishes a network connection with the proxy 390. Subsequently, the TMO 370 reads the file and serially transfers discrete portions of the file to the proxy 390. In an embodiment, the file portions are approximately 64 kilobytes in size, although small or larger portions may be similarly employed. Upon receiving a file portion, the proxy 390 provides an electronic acknowledgement receipt to the TMO 370. The TMO 370 provides a successive file portion only after receiving an acknowledgement receipt from the proxy 390. Additionally, the TMO 370 periodically informs the source client 310 of the file-transfer status, which may be viewable by the user on the display 250. Once the entire file has been transferred to the proxy 390, the TMO 370 informs the source client 310 of the file-transfer completion and is then terminated.

In an embodiment, the network connection between the TMO 370 and proxy 390 has a failure-recovery mode. For example, if the network connection is lost, the proxy 390 is terminated, the TMO 370 reinitiates the above procedure (i.e, set up proxy and network connection therewith), and informs the new proxy of the file-transfer status at the time of connection failure. Advantageously, in the event of such connection failure, the TMO 370 is configured to initiate the failure-recovery process itself; no instruction from the source client 310 or server 230 is necessary.

Upon creation of the proxy 390, the proxy requests allocation of space on the storage 270 into which the proxy may write the file data it receives. Once the entire file has been written to the storage 270, the proxy 390 informs the server 230 of the file-storage completion and is then terminated.

At or around the time that the proxy 390 is created, the TMO 370 creates a messaging mobile object (MMO) 305 that migrates to the recipient client 320 to inform the recipient client of the file being transferred from the source client 310. In doing so, the MMO provides the file-transfer information described above to the recipient client 320. In response to being so informed, the recipient client 320 creates a transfer mobile object (RTMO) 315 that includes the file-transfer information.

The RTMO 315 migrates to the mobile-agent runtime environment 380 executing on the server 230 and creates a proxy object 325 that functions as the RTMO's server-side agent for the file transfer. In an embodiment, the proxy 325 is, itself, a mobile object. After creating the proxy 325, the RTMO 315 returns to the recipient client 320.

Once the RTMO 315 returns to the user device 280, it establishes a network connection with the proxy 325. Additionally, the RTMO 315 instructs the recipient client 320 to set up an electronic file folder into which the transferred file will be placed.

In an embodiment, the proxy 325 may poll the server 230 to determine if the source proxy 390 has placed file data from the source device 210 into the storage 270. The proxy 325 reads from storage 270 each file portion stored therein by the source proxy 390 and provides each such file portion to the recipient client 320. Alternatively, the proxy 325 creates copies of the file portions, after which each such file portion is provided to the recipient client 320. In an embodiment, the proxy 325 reads and provides the file portions in a first-in-first-out (FIFO) manner. As such, the user device 280 may receive at least one portion of the file before the user device 210 has completed transferring the file to the server 230. Moreover, if the recipient client 320 is active at the time the source client 310 commences transfer of the file, the proxy 325 may read and provide the first file portion to the recipient client before the server 230 receives a subsequent file portion from the source client. If the recipient client 320 is not active (e.g., the user device 280 is off) at the time the source client 310 commences transfer of the file, the proxy 325 may read and provide the first file portion to the recipient client after the server 230 receives a subsequent file portion from the source client.

Once the entire file has been provided to the RTMO 315, the proxy 325 informs the server 230 of the file-share completion and is then terminated. Additionally, once the entire file has been transferred to its new file folder on the user device 280, the RTMO 315 informs the recipient client 320 of the file-transfer completion and is then terminated. Upon receipt of the file data by all designated recipients, the server 230 may purge the file portions from the storage 270.

In an embodiment, each portion of the transferred file is encrypted. In alternative embodiments, file encryption can be applied by the server 230 as file portions are received from the source client 310, or by the source device 210. In the case of encryption by the server 230, the server may have its own key applicable to the entire file data set. In the case of encryption by the source device 210, encryption and corresponding respective keys may be applied to each workspace, to each file or to each file portion as desired.

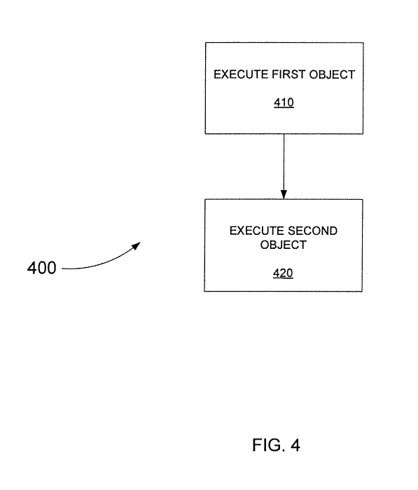

FIG. 4 illustrates a process 400 according to an embodiment of the invention. The process 400 is implementable in an electronic system coupled to or including a storage device. The process 400 is illustrated as a set of operations shown as discrete blocks. The process 400 may be implemented in any suitable hardware, software, firmware, or combination thereof. The order in which the operations are described is not to be necessarily construed as a limitation.

At a block 410, a first object is executed. The first object is operable to receive a plurality of portions of a file from a source device. Additionally, the first object is operable to store the portions to the storage device. In an embodiment, the first object is created by a mobile object created on the source device. For example, the TMO 370 creates a proxy object 390 that functions as the TMO's server-side agent for the file transfer. Subsequently, the TMO 370 reads the file and serially transfers discrete portions of the file to the proxy 390. The proxy 390 writes the file data it receives to the storage 270.

At a block 420, a second object is executed. The second object is operable to retrieve from the storage device a first portion of the file. The second objection is further operable to provide the first portion to a recipient device before the first object has received the entirety of the file from the source device. In an embodiment, the second object is created by a mobile object created on the recipient device. For example, The RTMO 315 creates a proxy object 325 that functions as the RTMO's server-side agent for the file transfer. The proxy 325 reads from storage 270 each file portion stored therein by the source proxy 390 and provides each such file portion to the recipient client 320. In an embodiment, the proxy 325 reads and provides the file portions in a first-in-first-out (FIFO) manner.

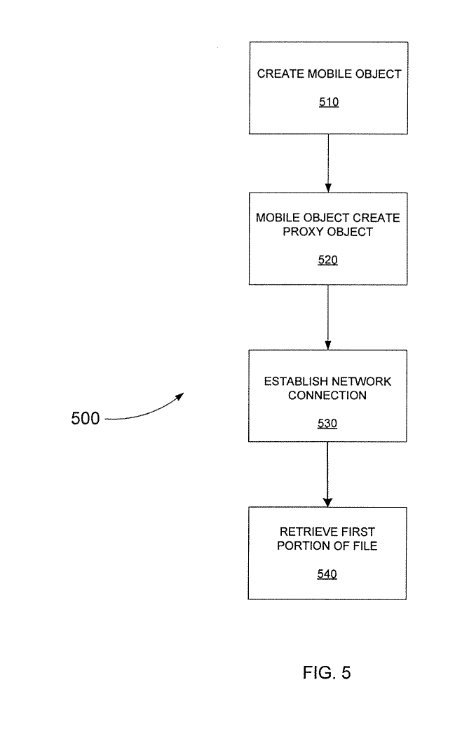

FIG. 5 illustrates a process 500 according to an embodiment of the invention. The process 500 is implementable in an electronic device coupled to an electronic system operable to receive a file from a source device. The process 500 is illustrated as a set of operations shown as discrete blocks. The process 500 may be implemented in any suitable hardware, software, firmware, or combination thereof. The order in which the operations are described is not to be necessarily construed as a limitation.

At a block 510, the electronic device creates a mobile object. For example, the recipient client 320 creates the RTMO 315.

At a block 520, the mobile object creates a proxy object at the electronic system. For example, the RTMO 315 migrates to the mobile-agent runtime environment 380 executing on the server 230 and creates a proxy object 325 that functions as the RTMO's server-side agent for the file transfer.

At a block 530, a network connection with the electronic system is established. For example, once the RTMO 315 returns to the user device 280, it establishes a network connection with the proxy 325.

At a block 540, a first portion of a plurality of portions of the file is retrieved from the electronic system. In an embodiment, the proxy object is operable to retrieve the file portions from a storage device coupled to the electronic system and provide the file portions to the electronic device. The first portion is received by the electronic device before the electronic system has received the entirety of the file from the source device. For example, The RTMO 315 creates a proxy object 325 that functions as the RTMO's server-side agent for the file transfer. The proxy 325 reads from storage 270 each file portion stored therein by the source proxy 390 and provides each such file portion to the recipient client 320. In an embodiment, the proxy 325 reads and provides the file portions in a first-in-first-out (FIFO) manner.

While a preferred embodiment of the invention has been illustrated and described, as noted above, many changes can be made without departing from the spirit and scope of the invention. For example, more than one recipient device may receive a shared file from the source device 210 in the manner described above with reference to the user device 280 and FIG. 3. In an embodiment, these multiple recipient devices can simultaneously receive the shared file by each deploying a respective proxy object to retrieve file portions from the server 230. Instead, the invention should be determined entirely by reference to the claims that follow.

The embodiments of the invention in which an exclusive property or privilege is claimed are defined as follows:

1. A system, comprising:
a server;
a source client executable on a first electronic device in communication with the server, the source client operable to send a file to the server; and
a recipient client executable on a second electronic device in communication with the server, the recipient client operable to retrieve from the server a first portion of a plurality of portions of the file before the server has received the entirety of the file from the source client.

2. The system of claim 1 wherein the file is sent to the server in a series of discrete portions of the file.

3. The system of claim 1 wherein the recipient client is operable to retrieve the first file portion before the server receives a second file portion from the source client.

4. The system of claim 1 wherein the recipient client is operable to retrieve the first file portion after the server receives a second file portion from the source client.

5. The system of claim 1 wherein the source client is operable to create a first mobile object, the first mobile object being operable to create a proxy object at the server.

6. The system of claim 5 wherein the first mobile object is operable to provide the plurality of file portions to the proxy object.

7. The system of claim 6 wherein the proxy object is operable to store the file portions in a storage device coupled to the server.

8. The system of claim 5 wherein the first mobile object is operable to create a second mobile object operable to notify the recipient client of the file being sent to the server.

9. The system of claim 1 wherein the recipient client is operable to create a mobile object, the mobile object being operable to create a proxy object at the server.

10. The system of claim 9 wherein the proxy object is operable to retrieve the file portions from a storage device coupled to the server and provide the file portions to the recipient client.

11. The system of claim 1 wherein the file portions are encrypted.

12. The system of claim 11 wherein the file portions are encrypted by the source client.

13. A method implementable in an electronic system having a storage component, the electronic system being coupled to a source device and a recipient device, the method comprising:
executing a first object operable to receive from the source device a plurality of portions of a file and store the portions to the storage component; and
executing a second object operable to retrieve from the storage component a first portion of the file and provide the first portion to the recipient device before the first object has received the entirety of the file from the source device.

14. The method of claim 13 wherein the first object is created by a mobile object, the mobile object being created on the source device.

15. The method of claim 13 wherein the second object is created by a mobile object, the mobile object being created on the recipient device.

16. A method implementable in an electronic device coupled to an electronic system, the method comprising:
establishing a network connection with the electronic system, the electronic system operable to receive a file from a source device; and
retrieving from the electronic system a first portion of a plurality of portions of the file before the electronic system has received the entirety of the file from the source device.

17. The method of claim 16 wherein establishing a network connection comprises:
the electronic device creating a mobile object; and
the mobile object creating a proxy object at the electronic system.

18. The method of claim 17 wherein the proxy object is operable to retrieve the file portions from a storage device coupled to the electronic system and provide the file portions to the electronic device.

19. A method of transferring a computer program product from at least one first computer to at least one second computer connected to the at least one first computer through a communication medium, the method comprising the steps of:
(a) accessing, on the at least one first computer, computer-executable instructions that, when executed on a data processing system, perform at least the steps of:
(1) establishing a network connection with a server, the server operable to receive a file from a source device, and
(2) retrieving from the server a first portion of the file before the server has received the entirety of the file from the source device; and
(b) transferring the computer-executable instructions from the at least one first computer to the at least one second computer through the communications medium.
